(19) United States
(12) Patent Application Publication
(10) Pub. No.: US 2024/0127456 A1
(43) Pub. Date: Apr. 18, 2024

(54) METHOD FOR LEARNING A TARGET OBJECT BY EXTRACTING AN EDGE FROM A DIGITAL MODEL OF THE TARGET OBJECT, AND A METHOD FOR AUGMENTING A VIRTUAL MODEL ON A REAL OBJECT CORRESPONDING TO THE DIGITAL MODEL OF THE TARGET OBJECT USING THE SAME

(71) Applicant: VIRNECT CO., LTD., Seoul (KR)

(72) Inventor: Thorsten KORPITSCH, Schwechat Wien (AT)

(21) Appl. No.: 18/489,407

(22) Filed: Oct. 18, 2023

(30) Foreign Application Priority Data
Oct. 18, 2022 (KR) 10-2022-0133999

(51) Int. Cl. G06T 7/13; G06T 19/00; G06V 10/44; G06V 20/20

(52) U.S. Cl. CPC G06T 7/13; G06T 19/006; G06V 10/44; G06V 20/20; G06T 2207/20081

(57) ABSTRACT

In a method for learning a target object, performed by a computer-aided design program of an authoring computing device, one embodiment of the present disclosure provides a method for learning a target object by extracting edges from a digital model of a target object, where the method comprises displaying the digital model of a target object which is an image recognition target, extracting a first edge with visibility greater than or equal to a threshold from a first area of the digital model of the target object, detecting a second edge with visibility greater than or equal to a threshold from a second area different from the first area of the digital model of the target object, and generating object recognition library data for recognizing a real object corresponding to the digital model of the target object based on the first and second edges.

### CROSS-REFERENCE TO RELATED APPLICATIONS

This application claims the priority of the Korean Patent Applications NO 10-2022-0133999, filed on Oct. 18, 2022, in the Korean Intellectual Property Office. The entire disclosures of all these applications are hereby incorporated by reference.

### BACKGROUND

### Field

The present disclosure relates to a method for learning a target object by extracting an edge from a digital model of the target object and a method for augmenting a virtual model on a real object corresponding to the digital model of the target object using the same.

### Related Art

Augmented reality is a visualization technology that enables intuitive visualization of 3D model information by matching a 3D model to a real-world image. However, to estimate the pose of a physical model as seen from the engineer's perspective, already-known reference information within the image is needed. A conventional approach constructs a database based on the views of a physical model captured from various angles and compares the captured views with an input image or tracks markers after an initial pose is input to the system by a user. However, it is difficult to apply the methods above to products in the production phase. Furthermore, these methods have the drawback of demanding significant time and effort from the user to define the initial pose, which limits their applicability to commercialization and diverse industries, since the use of markers is inevitable.

Because a markerless approach offers greater convenience and a wider range of applications compared to the marker-based methods, research on the markerless augmented reality has been active in recent years. The markerless tracking technique, introduced to address the limitations of the marker-based augmented reality, literally avoids the use of markers and directly utilizes graphic information from general magazines and posters or characteristic information of real objects. The markerless approach operates by employing advanced recognition technology to recognize an object in question and providing additional information related to the object.

However, even the markerless approach exhibits a problem that the accuracy of registration from extraction is degraded when environmental information, such as brightness and the shape or location of various objects in the background scene, is varied. Deep learning techniques have also been proposed as methods to improve the registration accuracy; however, considerable effort and time are still necessary for extracting feature information from diverse and complex real-world objects.

Also, for the application of the augmented reality technology in the medical or precision industrial fields requiring a high level of accuracy in tracking and recognition of real objects and registration between the real objects and augmented models or for the enhancement of the immersiveness of augmented reality, there is a need for quick and accurate detection of feature information from real objects.

### PRIOR ART REFERENCES

### Patents

(Patent 1) Korean application patent publication No. 10-2021-0108897
(Patent 2) Chinese application patent publication No. 108038761
(Patent 3) Chinese registered patent publication No. 110559075
(Patent 4) US patent application publication No. 2016-0171768

### SUMMARY

An embodiment of the present disclosure provides a method to address delays or costs of learning real objects, stemming from reduced accuracy due to diverse environmental factors and demand for advanced vision technology.

Also, an embodiment of the present disclosure provides a method that enables learning of real objects without involving repeated manufacturing of physical models for the learning of new or partially modified real objects.

Also, an embodiment of the present disclosure provides a method for learning the digital model of a target object on a computer-aided design program to ensure accurate and rapid learning of feature information of a real object.

Also, an embodiment of the present disclosure provides a method for learning the digital model of a target object on a computer-aided design program, which improves the precision of augmented content by increasing the accuracy in tracking and recognizing real objects.

Also, an embodiment of the present disclosure provides a method for tracking the pose of a real object at an improved speed by reducing the number of computations through the utilization of data learned from edges with visibility greater than or equal to a threshold, the edges being extracted from the digital model of a target object.

An embodiment of the present disclosure provides a method for learning a target object by extracting edges from a digital model of the target object, the method being performed by a computer-aided design program of an authoring computing device and comprising: displaying the digital model of a target object which is an image recognition target, extracting a first edge with visibility greater than a threshold from a first area of the digital model of the target object, detecting a second edge with visibility greater than a threshold from a second area different from the first area of the digital model of the target object, and generating object recognition library data for recognizing a real object corresponding to the digital model of the target object based on the first and second edges.

In another aspect of the present disclosure, the extracting of the first edge and the extracting of the second edge may extract the first and second edges respectively based on angle information formed by the respective normal vectors of adjacent planes including constituting elements of the digital model of the target object.

In another aspect of the present disclosure, when the size of an angle formed by the normal vectors of arbitrary adjacent planes among a plurality of planes of the first area including constituting elements of the digital model of the target object is greater than a threshold angle, the extracting of the first edge may select the edge formed by the corresponding adjacent planes as the first edge.

In another aspect of the present disclosure, when the size of an angle formed by the normal vectors of arbitrary adjacent planes among a plurality of planes of the second area including constituting elements of the digital model of the target object is greater than a threshold angle, the extracting of the second edge may select the edge formed by the corresponding adjacent planes as the second edge.

In another aspect of the present disclosure, the extracting of the first edge may determine first initial edges from the first area of the digital model and select the first edge with visibility greater than a threshold among the first initial edges.

In another aspect of the present disclosure, the extracting of the second edge may determine second initial edges from the second area of the digital model and select the second edge with visibility greater than a threshold among the second initial edges.

In another aspect of the present disclosure, the first area of the digital model of the target object may be an area of the digital model seen from a first viewpoint, and the second area of the digital model of the target object may be an area of the digital model seen from a second viewpoint different from the first viewpoint.

In another aspect of the present disclosure, the first area of the digital model of the target object may be an area of the digital model seen at a first position separated from the digital model, and the second area of the digital model of the target object may be an area of the digital model seen at a second position different from the first position and separated from the digital model.

In another aspect of the present disclosure, the method for learning a target object by extracting edges from a digital model of the target object may further comprise generating augmented content, registering the augmented content to the digital model of the target object, and storing content to which the augmented content is registered in conjunction with the digital model.

Another embodiment of the present disclosure provides a method for augmenting a virtual model to a real object, the method being performed by an augmented reality program of a terminal equipped with a camera and comprising: receiving and storing the object recognition library data, obtaining a captured image by photographing a surrounding environment, detecting a real object matching the stored object recognition library data within the obtained captured image, and displaying the detected real object by matching augmented content to the real object.

In another aspect of the present disclosure, the detecting of the real object matching the stored object recognition library data within the obtained captured image may include detecting the real object within the captured image based on the first edge with visibility greater than a threshold detected from a first area of the digital model of a target object and a second edge with visibility greater than a threshold detected from a second area different from the first area.

In another aspect of the present disclosure, the size of an angle formed by the respective normal vectors of adjacent planes including the first and second edges may be greater than or equal to a threshold angle.

The embodiment of the present disclosure may enable efficient learning of feature information of real objects and improves the precision of augmented content by increasing the accuracy in tracking and recognizing real objects.

Also, the embodiment of the present disclosure is performed based on edges with visibility greater than or equal to a threshold; therefore, the embodiments require a reduced number of computations and provide a method for learning the digital model of a target object with improved speed.

Also, the embodiment of the present disclosure may learn a real object to implement augmented reality even from a design stage before manufacturing of the real object.

Also, the embodiment of the present disclosure may generate learning data of a target object with robust features for recognition against various poses of a real object.

Also, object recognition library data may be shared and used across multiple user computing devices through a cloud database, thereby improving the utilization of learning data for target objects.

### BRIEF DESCRIPTION OF THE DRAWINGS

FIG. 1 is an exemplary block diagram of a system for implementing a method for augmenting a virtual model to a real object corresponding to the digital model of a target object by learning the target object based on the edges extracted from the digital model of the target object according to one embodiment.

FIGS. 2 and 3 are examples in which a user computing device tracks and recognizes a real object in the real-world environment and displays augmented content registered to the real object on a screen and a user check the displayed screen through the user computing device.

FIG. 4 is a flow diagram illustrating a method for learning a target object based on the edges extracted from the digital model of a target object according to one embodiment.

FIG. 5 briefly describes an example in which the digital model of an exemplary target object is displayed on a user interface of a computer-aided design program executed in an authoring computing device according to one embodiment.

FIG. 6 is a flow diagram illustrating a method for extracting first and second edges from the digital model of a target object according to one embodiment.

FIG. 7 illustrates a method for extracting edges from various areas of the digital model of an exemplary target object.

FIG. 8 illustrates a method for extracting edges from various areas of the digital model of a target object on a user interface of a computer-aided design program executed in an authoring computing device according to one embodiment.

FIG. 9 is a flow diagram illustrating a method for extracting a first edge from a first area of the digital model of a target object according to one embodiment.

FIG. 10 is a flow diagram illustrating a method for extracting a second edge from a second area of the digital model of a target object according to one embodiment.

FIG. 11 briefly describes an example in which the digital model of an exemplary target model and augmented content are displayed on a user interface of a computer-aided design program executed in an authoring computing device according to one embodiment.

### DESCRIPTION OF EXEMPLARY EMBODIMENTS

Since the present disclosure may be modified in various ways and may provide various embodiments, specific embodiments will be depicted in the appended drawings and described in detail with reference to the drawings. The effects and characteristics of the present disclosure and a method for achieving them will be clearly understood by referring to the embodiments described later in detail together with the appended drawings. However, it should be noted that the present disclosure is not limited to the embodiment disclosed below but may be implemented in various forms. In the following embodiments, the terms such as first and second are introduced to distinguish one element from the others, and thus the technical scope of the present disclosure should not be limited by those terms. Also, a singular expression should be understood to indicate a plural expression unless otherwise explicitly stated. The term include or have is used to indicate existence of an embodied feature or constituting element in the present specification; and should not be understood to preclude the possibility of adding one or more other features or constituting elements. Also, constituting elements in the figure may be exaggerated or shrunk for the convenience of descriptions. For example, since the size and thickness of each element in the figure has been arbitrarily modified for the convenience of descriptions, it should be noted that the present disclosure is not necessarily limited to what has been shown in the figure.

In what follows, embodiments of the present disclosure will be described in detail with reference to appended drawings. Throughout the specification, the same or corresponding constituting element is assigned the same reference number, and repeated descriptions thereof will be omitted.

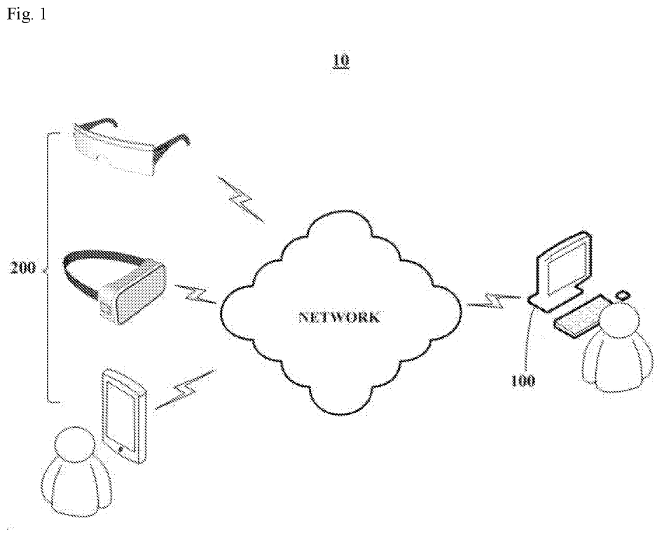

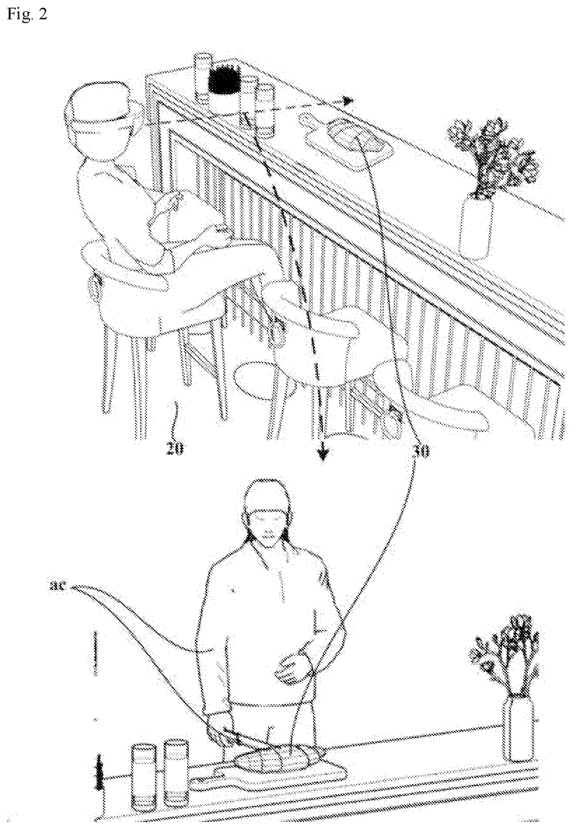

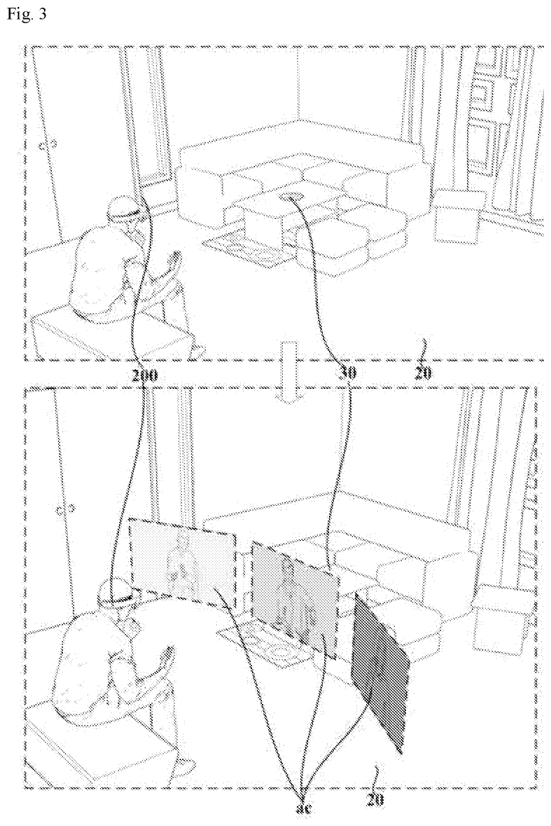

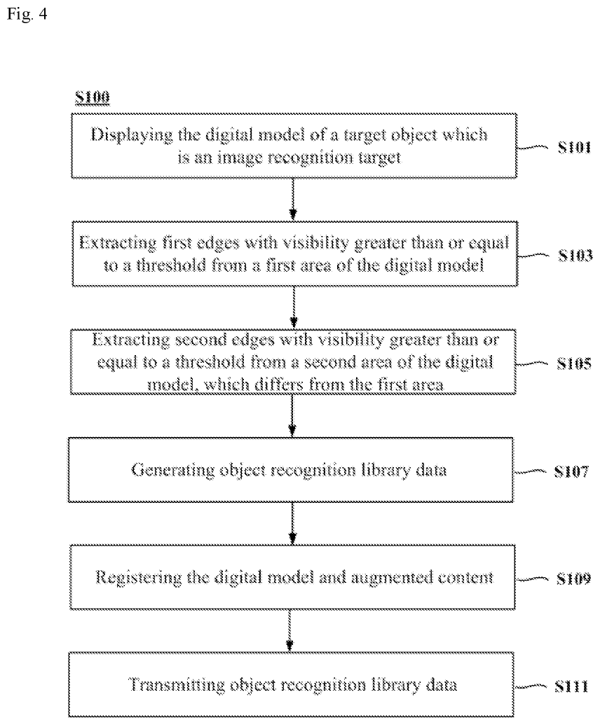

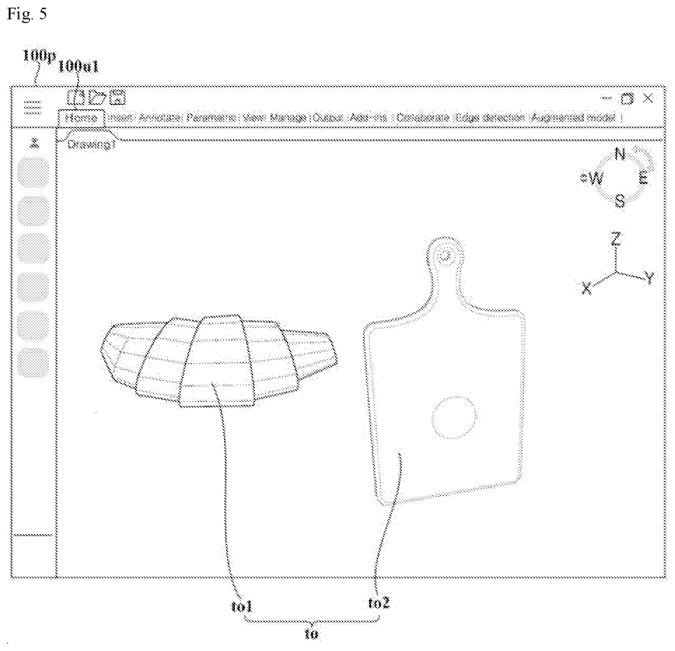

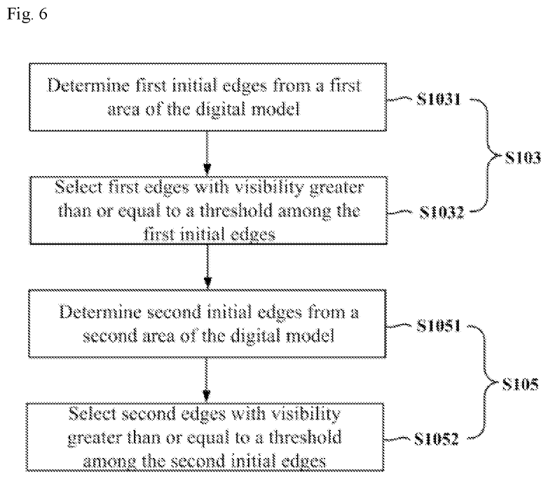

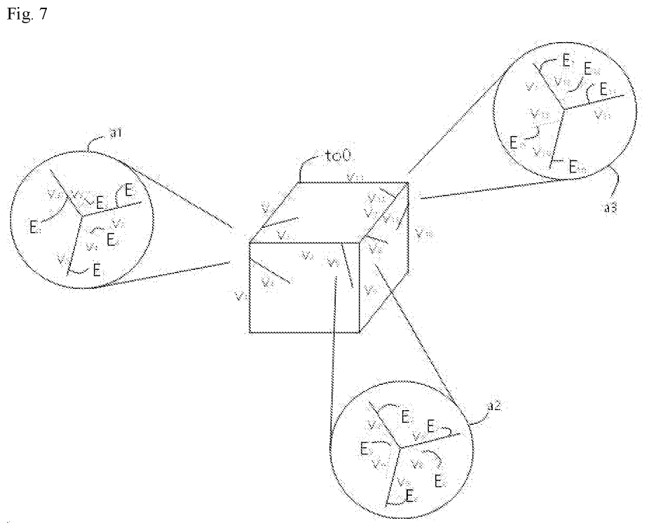

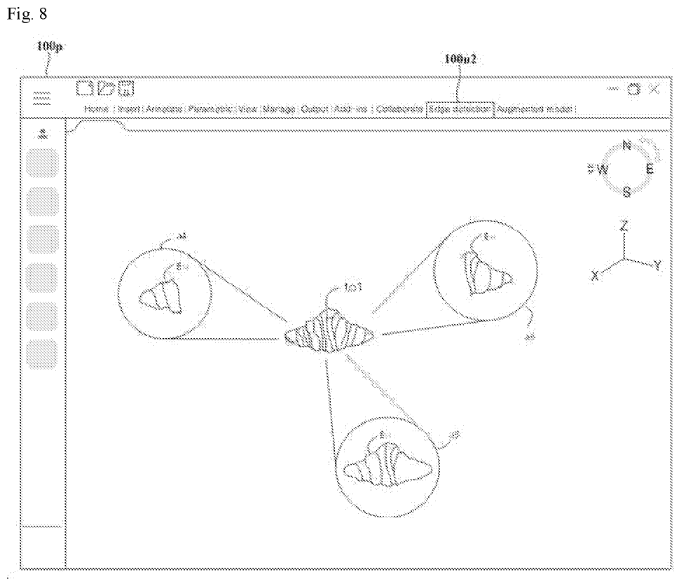

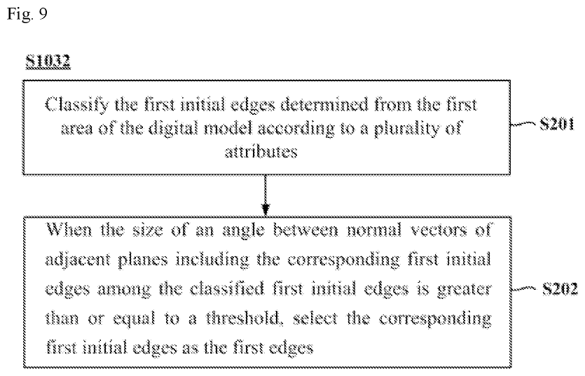

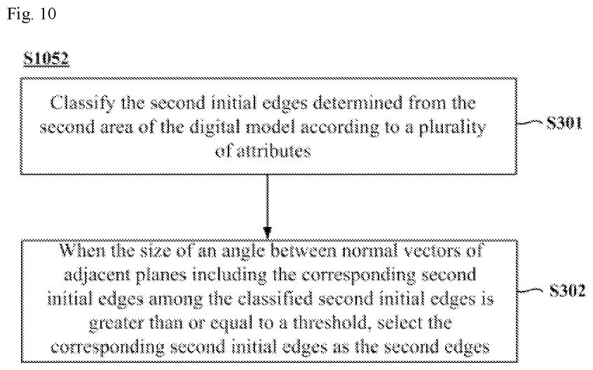

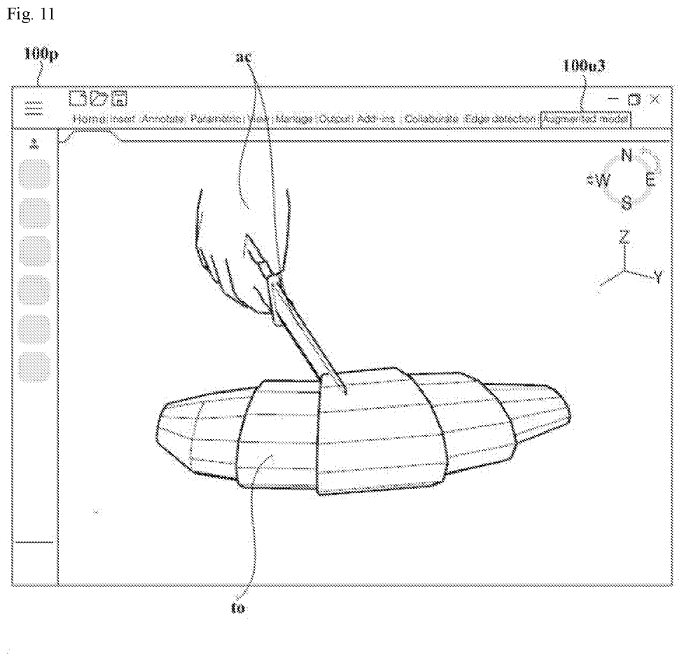

FIG. 1 is an exemplary block diagram of a system for implementing a method for augmenting a virtual model to a real object corresponding to the digital model of a target object by learning the target object based on the edges extracted from the digital model of the target object according to one embodiment. FIGS. 2 and 3 are examples in which a user computing device tracks and recognizes a real object in the real-world environment and displays augmented content registered to the real object on a screen and a user check the displayed screen through the user computing device. FIG. 4 is a flow diagram illustrating a method for learning a target object based on the edges extracted from the digital model of a target object according to one embodiment. FIG. 5 briefly describes an example in which the digital model of an exemplary target object is displayed on a user interface of a computer-aided design program executed in an authoring computing device according to one embodiment. FIG. 6 is a flow diagram illustrating a method for extracting first and second edges from the digital model of a target object according to one embodiment. FIG. 7 illustrates a method for extracting edges from various areas of the digital model of an exemplary target object. FIG. 8 illustrates a method for extracting edges from various areas of the digital model of a target object on a user interface of a computer-aided design program executed in an authoring computing device according to one embodiment. FIG. 9 is a flow diagram illustrating a method for extracting a first edge from a first area of the digital model of a target object according to one embodiment. FIG. 10 is a flow diagram illustrating a method for extracting a second edge from a second area of the digital model of a target object according to one embodiment. Also, FIG. 11 briefly describes an example in which the digital model of an exemplary target model and augmented content are displayed on a user interface of a computer-aided design program executed in an authoring computing device according to one embodiment.

System

Referring to FIGS. 1 to 3, the system 10 according to an embodiment of the present disclosure may include an authoring computing device 100 and a user computing device 200.

The system 10 according to an embodiment of the present disclosure may learn a target object based on the edges extracted from the digital model of a target object and augment various types of content ac to a real object 30 by tracking and recognizing the real object 30 in the real environment 20 using learned data.

The authoring computing device 100 provides an environment for extracting edges from the digital model of a target object and learning the target object. Also, the authoring computing device 100 may provide an environment for generating drawings of 3D models of various objects or an environment for generating and editing content such as various augmented models or various pieces of information for the objects. The authoring computing device 100 may provide, but not is limited to, various tools for drawing various types of content and may include mechanisms for importing existing files including an image and 2D or 3D objects.

Computer systems for augmented reality, referred to as a user computing device 200 in the embodiment of the present disclosure, include electronic devices that create augmented reality environments. Embodiments of an electronic device, user interfaces for the electronic device, and related processes for using the electronic device are described. In some embodiments, the user computing device 200 is a portable communication device, such as a mobile phone. Also, other portable electronic devices such as laptops or tablet computers with touch-sensitive planes (e.g., touch screen displays and/or touchpads) are optionally used. In some embodiments, the user computing device 200 may be a computing device that includes or communicates with one or more cameras rather than a portable communication device. Also, the user computing device 200 may include a Head Mounted Display (HMD) that enables a user wearing the device to be immersed in an augmented and/or virtual reality environment and explore and interact with the virtual environment through a variety of different inputs. In some embodiments, the user computing device 200 may include commercial products, such as Microsoft's HoloLens, Meta's Meta1/Meta2 glass, Google's Google glass, Canon's MD-10, and Magic Leap's Magic Leap One Creator Edition, and a device that provides the same or similar functions thereof.

Computer-Aided Design Program

A computer-aided design program 100p is installed on the authoring computing device 100. Various types of software developer kits (SDKs) or toolkits in the form of a library may be used for the computer-aided design program 100p.

As shown in FIG. 5, the computer-aided design program 100p run on the authoring computing device 100 creates a digital model to of a real object 30 before manufacturing of the real object 30. For example, the computer-aided design program 100p creates a first digital model to1 of a croissant and a second digital model of a cutting board to2 in the form of a 2D drawing or a 3D model.

Also, as shown in FIG. 11, the computer-aided design program 100p may create digital data for 3D model information or virtual information, which is the content ac augmented on a real object 30. Also, the computer-aided design program 100p implements physical and visual combinations between the digital model to and augmented content ac of the target object corresponding to the real object 30 and registers the positions of the digital model to and the augmented content ac.

Referring again to FIG. 5, the computer-aided design program 100p may provide a target object modeling interface 100u1 for modeling the target object. A 2D drawing or a 3D model of the digital model to of the target object may be produced on the target object modeling interface 100u1.

As shown in FIG. 8, the computer-aided design program 100p may provide an edge extraction interface 100u2. In various embodiments, the edge extraction interface 100u2 may be integrated with the target object modeling interface 100u1 to form a unified interface. In various embodiments, the edge extraction interface 100u2 may be executed by selecting a specific affordance on the target object modeling interface 100u1 and may be displayed over the target object modeling interface 100u1. Additionally, the edge extraction interface 100u2 may provide tools for extracting edges of the target object, modifying the extracted edges, and editing the edges.

As shown in FIG. 11, the computer-aided design program 100p may provide an augmented model implementation interface 100u3 to provide various tools for drawing an augmented model. In various embodiments, the augmented model implementation interface 100u3 may be integrated with the target object modeling interface 100u1, forming a unified interface.

A Method for Learning a Target Object

Referring to FIG. 4, a method S100 for learning a target object by extracting edges from the digital model of a target object according to one embodiment may comprise displaying the digital model of a target object which is an image recognition target S101, extracting a first edge with visibility greater than or equal to a threshold from a first area of the digital model S103, extracting a second edge with visibility greater than or equal to a threshold from a second area different from the first area of the digital model S105, generating object recognition library data S107, registering the digital model and augmented content S109, and transmitting the object recognition library data S111.

In what follows, the respective steps will be described in detail with reference to related drawings.

Displaying the Digital Model of a Target Object which is an Image Recognition Target S101

As shown in FIG. 5, the computer-aided design program 100p may display the digital model to of a target object. The displayed digital model to of the target object is an illustrative 3D model and may be produced through the target object modeling interface 100u1. In some embodiments, the computer-aided design program 100p may retrieve and display a pre-stored digital model to of the target object. According to some embodiments, the digital model to of the target object may be created on another computer-aided design program. Also, the computer-aided design program 100p may import and display a digital model to or a 2D image of the target object produced on another type of computer-aided design program.

Extracting First and Second Edges from a Digital Model S103, S105

The computer-aided design program 100p may determine an edge of the digital model to based on the attribute information of the digital model to. The attribute information of the digital model to may include coordinate information of each element constituting the digital model to. Here, the element may include at least one of points, lines, or surfaces forming the digital model to. Also, in various embodiments, the attribute information of the digital model to may include color information of each element constituting the digital model to.

Various edge extraction algorithms may be used to determine the edges of the digital model to. For example, the computer-aided design program 100p may extract edges based on angle information between normal vectors of planes including arbitrary points constituting the outer shape of the digital model to; however, the present disclosure is not limited to the specific example above.

Referring to FIG. 6, the extracting of the first edge from the digital model to S103 may include determining first initial edges from a first area of the digital model to S1031 and selecting a first edge with visibility greater than or equal to a threshold among the first initial edges S1032. Also, the extracting of the second edge from the digital model to S105 may include determining second initial edges from a second area of the digital model to S1051 and selecting a second edge with visibility greater than or equal to a threshold among the second initial edges S1052.

Here, visibility refers to the visual prominence of an edge, where an edge with high visibility may be easily recognized by an edge extraction algorithm. Also, users may set the threshold for visibility in various ways to their preferences.

In what follows, the extracting of the first edge S103 and the extracting of the second edge S105 will be described in detail with reference to FIGS. 7 and 8.

As shown in FIG. 7, an exemplary digital model to0 may comprise a plurality of edges E₁, E₂, E₃, E₄, E s, E₆, E₇, E₈, E₉, E₁₀, E₁₁, E₁₂, E₁₃. The digital model to0 may be displayed on an edge extraction interface 100u2. For the convenience of descriptions, FIG. 7 omits the edge extraction interface 100u2.

Each of the plurality of edges E₁, E₂, E₃, E₄, E₅, E₆, E₇, E₈, E₉, E₁₀, E₁₁, E₁₂, E₁₃ of the digital model to0 has a unique visibility V₁, V₂, V₃, V₄, V₅, V₆, V₇, V₈, V₉, V₁₀, V₁₁, V₁₂, V₁₃ The visibilities V₁, V₂, V₃, V₄, V s, V₆, V₇, V₈, V₉, V₁₀, V₁₁, V₁₂, V₁₃ of the plurality of edges E₁, E₂, E₃, E₄, E₅, E₆, E₇, E₈, E₉, E₁₀, E₁₁, E₁₂, E₁₃ may have different values from each other.

For example, the digital model to0 may have a shape similar to that of a cuboid. Edges E₁, E₂, E₃, E₄, E₅ may be determined from a first area a1 of the digital model to0. The first area a1 may be the area of the digital model to0 seen from a first viewpoint. Here, the first viewpoint may correspond to a first position separated from the front upper left corner of the digital model to0, from which the digital model to0 is viewed.

As described above, the edges E₁, E₂, E₃, E₄, E₅ of the first area a1 of digital model to0 as seen from the first viewpoint may be referred to as the ‘first initial edges.’ The first initial edges E₁, E₂, E₃, E₄, E₅ may include those edges E₁, E₂, E₃ with relatively high visibility V₁, V₂, V₃ and those edges E₄, E₅ with relatively low visibility V₄, V₅. For example, the visibility V₁, V₂, V₃ of edge E₁, E₂, E₃ may be greater than or equal to a predetermined threshold, while the visibility V₄, V₅ of edge E₄, E₅ may be smaller than the predetermined threshold. Here, the predetermined threshold may be set to various values by the user. The edges E₁, E₂, E₃ with visibility V₁, V₂, V₃ higher than the threshold may be recognized more easily by an edge extraction algorithm than the edges E₄, E₅ with visibility V₄, V₅ lower than the threshold.

The step of extracting a first edge S103 may determine the first initial edges E₁, E₂, E₃, E₄, E₅ of the first area a1 of the digital model to0 seen from the first viewpoint S1031 and select first edges E₁, E₂, E₃ with visibility V₁, V₂, V₃ greater than the threshold S1032.

Also, edges E₂, E₆, E₇, E₈, E₉ may be determined from the second area a2 of the digital model to0. The second area a2 may be an area of the digital model to0 seen from a second viewpoint different from the first viewpoint. Here, the second viewpoint may correspond to a second position separated from the front upper right corner of the digital model to0, from which the digital model to0 is viewed.

As described above, the edges E₂, E₆, E₇, E₈, E₉ of the second area a2 of digital model to0 as seen from the second viewpoint may be referred to as the ‘second initial edges.’ The second initial edges E₂, E₆, E₇, E₈, E₉ may include those edges E₂, E₆, E₇ with relatively high visibility V₂, V₆, V₇ and those edges E₈, E₉ with relatively low visibility V₈, V₉. For example, the visibility V₂, V₆, V₇ of edge E₂, E₆, E₇ may be greater than or equal to a predetermined threshold, while the visibility V₈, V₉ of edge E₈, E₉ may be smaller than the predetermined threshold. Here, the predetermined threshold may be set to various values by the user. The edges E₂, E₆, E₇ with visibility V₂, V₆, V₇ higher than the threshold may be recognized more easily by an edge extraction algorithm than the edges E₈, E₉ with visibility V₈, V₉ lower than the threshold.

The step of extracting a second edge S105 may determine the second initial edges E₂, E₆, E₇, E₈, E₉ of the second area a2 of the digital model to0 seen from the second viewpoint S1051 and select second edges E₂, E₆, E₇ with visibility V₂, V₆, V₇ greater than or equal to the threshold S1052.

Similarly, edges E₇, E₁₀, E₁₁, E₁₂, E₁₃ may be determined from the third area a3 of the digital model to0. The third area a3 may be an area of the digital model to0 seen from a third viewpoint different from the first and second viewpoints. Here, the third viewpoint may correspond to a third position separated from the rear upper right corner of the digital model to0, from which the digital model to0 is viewed.

As described above, the edges E₇, E₁₀, E₁₁, E₁₂, E₁₃ of the third area a3 of digital model to0 as seen from the third viewpoint may be referred to as the ‘third initial edges.’ The third initial edges E₇, E₁₀, E₁₁, E₁₂, E₁₃ may include those edges E₇, E₁₀, E₁₁ with relatively high visibility V₇, V₁₀, V₁₁ and those edges E₁₂, E₁₃ with relatively low visibility V₁₂, V₁₃. For example, the visibility V₇, V₁₀, V₁₁ of edge E₇, E₁₀, E₁₁ may be greater than or equal to a predetermined threshold, while the visibility V₁₂, V₁₃ of edge E₁₂, E₁₃ may be smaller than the predetermined threshold. Here, the predetermined threshold may be set to various values by the user. The edges E₇, E₁₀, E₁₁ with visibility V₇, V₁₀, V₁₁ higher than the threshold may be recognized more easily by an edge extraction algorithm than the edges E₁₂, E₁₃ with visibility V₁₂, V₁₃ lower than the threshold.

The step of extracting a third edge may determine the third initial edges E₇, E₁₀, E₁₁, E₁₂, E₁₃ of the third area a3 of the digital model to0 seen from the third viewpoint and select third edges E₇, E₁₀, E₁₁ with visibility V₇, V₁₃, V₁₁ greater than the threshold.

As described above, initial edges may be determined respectively from a plurality of the areas including the first, second, and third areas of the digital model to0 seen sequentially from a plurality of different positions including the first, second, and third positions separated from the digital model to0. Also, edges with visibility greater than or equal to a threshold may be selected and extracted from the corresponding initial edges of each of the plurality of areas including the first, second, and third areas. Here, the first position is a position spaced apart from the digital model to0 by a first distance in a first direction, the second position is a position spaced apart from the digital model to0 by a second distance in a second direction, and the third position is a position spaced apart from the digital model to0 by a third distance in a third direction.

The first to third directions and the first to third distances may be set so that the first to third positions are different from each other. For example, when the first, second, and third directions are the same, the first, second, and third distances may be different from each other. Also, for example, when the first, second, and the third distances are the same, the first, second, and third directions may be different from each other.

According to one embodiment, initial edges may be determined from each of the areas seen as the digital model to0 is sequentially viewed from a plurality of positions spaced apart by the same distance in different directions from the digital model to0.

Referring to FIG. 8, a digital model to1 of a croissant-shaped target object may be displayed on the edge extraction interface 100u2 provided by the computer-aided design program 100p. The computer-aided design program 100p may extract the first edge E₁₄ from the first area a4 of the digital model to1, extract the second edge E₁₅ from the second area a5, and extract the third edge E₁₆ from the third area a6.

In this case, the first edge E₁₄ may be an edge with visibility greater than or equal to a threshold among edges seen within the first area a4 of the digital model to1. Additionally, the second edge E₁₅ may be an edge with visibility greater than or equal to a threshold among edges seen within the second area a5 of the digital model to1. Furthermore, the third edge E₁₆ may be an edge with visibility greater than or equal to a threshold among edges seen within the third area a6 of the digital model to1.

In what follows, with reference to FIGS. 9 and 10, a method for selecting edges with visibility greater than or equal to a threshold among exemplary initial edges will be described. However, a method for selecting edges with visibility greater than or equal to a threshold among exemplary initial edges is not limited to the method described with reference to FIGS. 9 and 10 but may be implemented using various other methods in addition to the method illustrated with reference to FIGS. 9 and 10.

Referring to FIG. 9, the step S1032 of selecting first edges E₁, E₂, E₃ with visibility greater than or equal to a threshold among first initial edges E₁, E₂, E₃, E₄, E₅ may include a step S201 of classifying the first initial edges E₁, E₂, E₃, E₄, E₅ determined from the first area a1 of the digital model to0 according to a plurality of attributes and a step S202 in which, when the size of an angle between normal vectors of adjacent planes including any one of the first initial edges E₁, E₂, E₃, E₄, E₅ is greater than or equal to a threshold angle, the corresponding first initial edges E₁, E₂, E₃ are selected as the first edges E₁, E₂, E₃.

For example, the computer-aided design program 100p may classify initial edges determined from various areas of the digital model to0 according to their attributes. For example, the determined initial edges may be classified as sharp, dull, and flat edges.

Among the initial edges determined from the digital model to0, if normal vectors of planes comprising the edges form an angle within a first angular size range, the edges may be classified as sharp edges; if normal vectors of planes comprising the edges form an angle within a second angular size range (c1-c2, c2<b1), the maximum angle of which is smaller than the smallest angle size within the first angular size range (b1-b2), the edges may be classified as dull edges. In some embodiments, those edges within a third angular size range (d1-d2, d2<c1), the maximum angle of which is smaller than the smallest angle size c1 within the second angular size range (c1-c2), may be considered as not conveying visual attributes in the digital model to0 and thus be determined as non-edges. Here, the size of an angle between normal vectors of planes, which falls within the third angular size range, may be effectively close to 0.

Also, since the planes of the digital model to0 do not contain edges, no edges will be detected on the planes. However, if a line is drawn on a plane, the computer-aided design program 100p may determine the line on the plane as an edge and classify the line as a flat edge. In other words, when an angle between a normal vector of a plane including at least part of a line and neighboring constituting elements of the digital model to0 and a normal vector of a plane including constituting elements of the digital model to0 adjacent to the line becomes 0, the corresponding line may be classified as a flat edge.

Referring again to FIG. 9, in the step S201 of classifying the first initial edges E₁, E₂, E₃, E₄, E s determined from the first area a1 of the digital model to0 according to a plurality of attributes, the first initial edges E₁, E₂, E₃, E₄, E₅ may be classified as sharp, dull, and flat edges.

In this case, among the first initial edges E₁, E₂, E₃, E₄, E₅ determined from the first area a1 of the digital model to0, those edges E₁, E₂, E₃ may be classified as sharp edges, and those edges E₄, E₅ may be classified as dull edges or flat edges.

Also, in the step S202 in which, when the size of an angle between normal vectors of adjacent planes including any one of the first initial edges E₁, E₂, E₃, E₄, E₅ is greater than or equal to a threshold angle, the corresponding first initial edges E₁, E₂, E₃ are selected as the first edges E₁, E₂, E₃, those edges E₁, E₂, E₃ classified as dull or flat edges may be selected as first edges E₁, E₂, E₃, while those edges E₄, E₅ classified as dull or flat edges may be excluded from selection. However, the present disclosure is not limited to the specific description, and a threshold angle may be changed to allow those edges classified as dull edges to be selected as the first edges.

As described above, the threshold angle may be changed so that the edges classified as sharp edges among the first initial edges are selected as the first edges; alternatively, the threshold angle may be changed so that the edges classified as sharp or dull edges among the first initial edges are selected as the first edges.

Also, referring to FIG. 10, the step S1052 of selecting a second edge E₂, E₆, E₇ with visibility greater than or equal to a threshold among the second initial edges E₂, E₆, E₇, E₈, E₉ S1052 may include a step S301 of classifying the second initial edges E₂, E₆, E₇, E₈, E₉ determined from the second area a2 of the digital model to0 according to a plurality of attributes and a step S302 in which, when the size of an angle between normal vectors of adjacent planes including any one of the second initial edges E₂, E₆, E₇, E₈, E₉ is greater than or equal to a threshold angle, the corresponding second initial edges E₂, E₆, E₇ are selected as the first edges E₂, E₆, E₇.

Generating Object Recognition Library Data S107

The computer-aided design program 100p may generate object recognition library data based on extracted edges.

In some embodiments, the object recognition library data may include at least one of position information of the digital model to of a target object, positions of edges on the digital model to of the target object, relative positions among edges, and edge attributes.

In various embodiments, the computer-aided design program 100p may learn edges extracted from the digital model to through a pre-trained deep learning neural network and detect feature information of robust features for the digital model to of the target object.

For example, the computer-aided design program 100p may detect feature information of robust features for the digital model to1 of a target object by learning a first edge E₁₄, a second edge E₁₅, and a third edge E₁₆ with visibility greater than or equal to a threshold, extracted from the digital model to1 of FIG. 8. In this case, the number of computations is reduced since learning data is performed based on the first edge E₁₄, second edge E₁₅, and third edge E₁₆ with visibility greater than or equal to the threshold among the edges seen respectively from the first area a4, second area a5, and third area a6 of the digital model to1; therefore, the speed of learning data may be improved compared to the case in which all of the edges are employed.

In various embodiments, the computer-aided design program 100p may provide an environment for testing robustness of detected sample points.

Registering the Digital Model and Augmented Content S109

Referring to FIG. 11, the computer-aided design program 100p may provide various tools to create augmented content ac to be registered with the digital model to of a target object. In various embodiments, the computer-aided design program 100p may retrieve and display pre-stored augmented content ac. According to some embodiments, the augmented content ac may be created on another computer-aided design program. Also, the computer-aided design program 100p may import and display augmented content ac produced on another type of computer-aided design program.

The computer-aided design program 100p provides an interface that allows displayed augmented content ac to be moved, rotated, enlarged, and reduced with respect to the x, y, and z axes, thereby ensuring thorough and precise registration between the augmented content ac and the digital model to of the target object. Here, it should be noted that the concept of registration as described above includes not only the physical contact between the augmented content ac and the digital model to of the target object but also setting of a separation distance from the digital model to of the target object and setting of a display position of the augmented content ac with respect to the digital model to of the target object. Also, the computer-aided design program 100p may provide a tool for assigning dynamic attributes to the augmented content ac for the simulation of the augmented content ac with changing positions and/or shapes over time. Also, the computer-aided design program 100p may provide an interface for adding various pieces of information as well as an augmented model.

Transmitting Object Recognition Library Data S111

The authoring computing device 100 may transmit object recognition library data to an external device in response to a transmission request from the external device. Here, the external device may be the user computing device 200 but is not limited thereto.

The user computing device 200 may receive object recognition library data from, for example, the authoring computing device 100 that stores the object recognition library data.

Referring again to FIGS. 2 and 3, the user computing device 200 may track a real object corresponding to the digital model to of the target object among the captured images of objects in the real environment 20. The user computing device 200 may detect the real object 30 from the captured images based on the edges extracted from the digital model to of the target object. The user computing device 200 may apply an edge extraction algorithm to extract feature information in the form of sample points from the images taken while tracking the real object and recognize the real object 30 by comparing it with object recognition library data. When recognizing the real object 30, the user computing device 200 may retrieve the augmented content ac stored in the database, authoring computing device 100, or another server, augment the augmented content ac through registration and rendering with the real object 30, and adjust event flags for the execution of stored interaction events.

Depending on the angle and distance from which the camera of the user computing device 200 observes the real object 30, the augmented virtual model or various other pieces of virtual information may appear in different shapes and sizes. In various embodiments, the user computing device 200 may display various pieces of information related to the real object 30.

In various embodiments, a user may control the augmented content ac displayed on the user computing device 200 through the manipulation of the user computing device 200.

In various embodiments, the user computing device 200 provides an interface that allows the user to move, rotate, enlarge, and reduce the displayed augmented content ac with respect to the x, y, and z axes, thereby ensuring thorough and detailed observation of the augmented content ac. Also, the user computing device 200 provides richer information beyond static information by allowing the interface to incorporate various pieces of information in addition to the augmented model. Also, the user computing device 200 may assess the changes in an existing device before and after the installation of a new component displayed as an augmented model of the existing device, augment a virtual structure to an area difficult to see with the naked eye, or perform a simulation of the augmented model changing sequentially over time by introducing a 4D concept with a time dimension added to the 3D spatial dimensions along the x, y, and z axes. In various embodiments, the user computing device 200 may provide interaction functionality, and in some embodiments, an additional controller may be used to implement the interaction.

The embodiments of the present disclosure as described above may be implemented in the form of program commands which may be executed through various types of computer means and recorded in a computer-readable recording medium. The computer-readable recording medium may include program commands, data files, and data structures separately or in combination thereof. The program commands recorded in the computer-readable recording medium may be those designed and configured specifically for the present disclosure or may be those commonly available for those skilled in the field of computer software. Examples of a computer-readable recoding medium may include magnetic media such as hard-disks, floppy disks, and magnetic tapes; optical media such as CD-ROMs and DVDs; and hardware devices specially designed to store and execute program commands such as ROM, RAM, and flash memory. Examples of program commands include not only machine codes such as those generated by a compiler but also high-level language codes which may be executed by a computer through an interpreter and the like. The hardware device may be configured to be operated by one or more software modules to perform the operations of the present disclosure, and vice versa.

Specific implementation of the present disclosure are embodiments, which does not limit the technical scope of the present disclosure in any way. For the clarity of the specification, descriptions of conventional electronic structures, control systems, software, and other functional aspects of the systems may be omitted. Also, connection of lines between constituting elements shown in the figure or connecting members illustrate functional connections and/or physical or circuit connections, which may be replaceable in an actual device or represented by additional, various functional, physical, or circuit connection. Also, if not explicitly stated otherwise, “essential” or “important” elements may not necessarily refer to constituting elements needed for application of the present disclosure.

Also, although detailed descriptions of the present disclosure have been given with reference to preferred embodiments of the present disclosure, it should be understood by those skilled in the corresponding technical field or by those having common knowledge in the corresponding technical field that the present disclosure may be modified and changed in various ways without departing from the technical principles and scope specified in the appended claims. Therefore, the technical scope of the present disclosure is not limited to the specifications provided in the detailed descriptions of this document but has to be defined by the appended claims.

### DETAILED DESCRIPTION OF MAIN ELEMENTS

10: System
20: Real environment
30: Real object
100: Authoring computing device
200: User computing device
ac: augmented content
100: Computer-aided design program
100u1: Target object modeling interface
100u2: Edge extraction interface
100u3: Augmented model implementation interface
to, to0, to1, to2: Digital model

What is claimed is:

1. A method for learning a target object by extracting edges from a digital model of a target object, performed by a computer-aided design program of an authoring computing device, the method comprising:
displaying the digital model of a target object which is an image recognition target;
extracting a first edge with visibility greater than or equal to a threshold from a first area of the digital model of the target object;
detecting a second edge with visibility greater than or equal to a threshold from a second area different from the first area of the digital model of the target object; and
generating object recognition library data for recognizing a real object corresponding to the digital model of the target object based on the first and second edges.

2. The method of claim 1, wherein the extracting of the first edge and the extracting of the second edge extract the first and second edges respectively based on angle information formed by the respective normal vectors of adjacent planes including constituting elements of the digital model of the target object.

3. The method of claim 1, wherein, when the size of an angle formed by the normal vectors of arbitrary adjacent planes among a plurality of planes of the first area including constituting elements of the digital model of the target object is greater than or equal to a threshold angle, the extracting of the first edge selects the edge formed by the corresponding adjacent planes as the first edge, and
when the size of an angle formed by the normal vectors of arbitrary adjacent planes among a plurality of planes of the second area including constituting elements of the digital model of the target object is greater than or equal to a threshold angle, the extracting of the second edge selects the edge formed by the corresponding adjacent planes as the second edge.

4. The method of claim 1, wherein the extracting of the first edge determines first initial edges from the first area of the digital model and selects the first edge with visibility greater than or equal to a threshold among the first initial edges, and
the extracting of the second edge determines second initial edges from the second area of the digital model and selects the second edge with visibility greater than or equal to a threshold among the second initial edges.

5. The method of claim 1, wherein the first area of the digital model of the target object is an area of the digital model seen from a first viewpoint, and the second area of the digital model of the target object is an area of the digital model seen from a second viewpoint different from the first viewpoint.

6. The method of claim 1, wherein the first area of the digital model of the target object is an area of the digital model seen at a first position separated from the digital model, and the second area of the digital model of the target object is an area of the digital model seen at a second position different from the first position and separated from the digital model.

7. The method of claim 1, further comprising:
generating augmented content, registering the augmented content to the digital model of the target object, and storing content to which the augmented content is registered in conjunction with the digital model.

8. A method for augmenting a virtual model to a real object, performed by an augmented reality program of a terminal equipped with a camera, the method comprising:
receiving and storing the object recognition library data;
obtaining a captured image by photographing a surrounding environment;
detecting a real object matching the stored object recognition library data within the obtained captured image; and
displaying the detected real object by matching augmented content to the real object.

9. The method of claim 8, wherein the detecting of the real object matching the stored object recognition library data within the obtained captured image includes:
detecting the real object within the captured image based on the first edge with visibility greater than or equal to a threshold detected from a first area of the digital model of a target object and a second edge with visibility greater than or equal to a threshold detected from a second area different from the first area.

10. The method of claim 9, wherein the size of an angle formed by the respective normal vectors of adjacent planes including the first and second edges is greater than or equal to a threshold angle.
